(19) United States
(12) Patent Application Publication
(10) Pub. No.: US 2025/0377893 A1
(43) Pub. Date: Dec. 11, 2025

(54) TRACKING AND SECURELY RECORDING COMPUTING RESOURCE USAGE

(71) Applicant: Microsoft Technology Licensing, LLC, Redmond, WA (US)

(72) Inventors: Subhav MITAL, Redwood City, CA (US); Julio A. COLON-MARCANO, Northridge, MA (US)

(73) Assignee: Microsoft Technology Licensing, LLC, Redmond, WA (US)

(21) Appl. No.: 18/734,995

(22) Filed: Jun. 5, 2024

(51) Int. Cl. G06F 9/32; H04L 9/00; H04L 9/32

(52) U.S. Cl. CPC G06F 9/321; H04L 9/3297; H04L 9/50

(57) ABSTRACT

According to examples, an apparatus includes a processor and a memory on which is stored machine-readable instructions that when executed by the processor, cause the processor to scan an application programming interface (API) for a specified label in the API, in which the specified label includes a counter that increments based on an API interacting with a computing resource for a caller of the API. The processor also reads a value of a counter in the specified label and records the read value of the counter and an identifier of an entity associated with the caller of the API onto a decentralized blockchain. The computing resource usage by the entity may thus be securely recorded, such that the computing resource usage may be used for any of a number of purposes, such as invoicing, usage tracking, and/or security.

### BACKGROUND

Customers of computer processing services are often billed using one of a variety of types of billing models. One of the models includes a pay-as-you-go billing model in which customers are billed based on the actual amount of computing resources that they use. Another type of billing model includes a subscription-based model in which customers pay a recurring fee for a predefined set of resources or services. A further type of model is a usage-based billing model in which customers are charged based on specific metrics, such as the number of API calls, the volume of data processed, or the number of transactions conducted.

### BRIEF DESCRIPTION OF DRAWINGS

Features of the present disclosure are illustrated by way of example and not limited in the following figure(s), in which like numerals indicate like elements, in which:

FIG. 1 shows a block diagram of a system including an apparatus for determining and securely recording values of counts (e.g., numbers of times) that an API interacted with a computing resource over at least one period of time for an entity, in accordance with an embodiment of the present disclosure;

FIG. 2A shows a block diagram of a system including a plurality of apparatuses for determining and securely recording values of a number of counts that one or more APIs interacted with one or more computing resources over at least one period of time for one or more entities, in accordance with an embodiment of the present disclosure;

FIG. 2B shows a block diagram of the system shown in FIG. 2A, in which some of the APIs and computing resources are in separate areas with respect to each other, in accordance with an embodiment of the present disclosure;

FIG. 3A shows an example of an API for a Kubernetes Cluster in which labels have been added, in accordance with an embodiment of the present disclosure;

FIG. 3B shows an example of an API, in this example, an ARM template, for a computing resource in which a label has been added, in accordance with an embodiment of the present disclosure;

FIG. 4 depicts a flow diagram of a method for tracking computer resource usage and for recording transaction data corresponding to the computing resource usage in a decentralized blockchain, in accordance with an embodiment of the present disclosure; and

FIG. 5 shows a block diagram of a computer-readable medium that has stored thereon computer-readable instructions for tracking computer resource usage and for recording transaction data corresponding to the computing resource usage onto a decentralized blockchain, in accordance with an embodiment of the present disclosure.

### DETAILED DESCRIPTION

For simplicity and illustrative purposes, the principles of the present disclosure are described by referring mainly to embodiments and examples thereof. In the following description, numerous specific details are set forth in order to provide an understanding of the embodiments and examples. It will be apparent, however, to one of ordinary skill in the art, that the embodiments and examples may be practiced without limitation to these specific details. In some instances, well known methods and/or structures have not been described in detail so as not to unnecessarily obscure the description of the embodiments and examples. Furthermore, the embodiments and examples may be used together in various combinations.

Throughout the present disclosure, the terms “a” and “an” are intended to denote at least one of a particular element. As used herein, the term “includes” means includes but not limited to, the term “including” means including but not limited to.

A number of conventional billing models exists, such as pay-as-you-go and usage-based billing models that seek to track usage of computing resources and/or specific metrics by customers and to generate invoices based on the tracked usage. The conventional billing models may suffer from some challenges, such as inflexibility in the manners in which the usage of the computing resources are tracked and lack of security in the storage of the tracked usage. That is, once a manner in which the usage of the computing resources is set, it may be relatively difficult to change. In addition, the tracked usage data may readily be altered, which may, among other things, result in a customer being billed improperly, result in potential security issues, etc.

Disclosed herein are apparatuses and methods for tracking computing resource usage and for securely recording the tracked computing resource usage in a decentralized blockchain. According to examples, a set of instructions, such as an application programming interface (API), is written to include a label that includes a key value pair of a type of counter and a value of the counter. An API may be defined as a set of rules and protocols that enable a caller (e.g., a program, an application, a script, a user, or the like) that makes a request to an API to interact with (e.g., access, use, read from, write to, perform actions, etc.) a computing resource provided by the API. An API endpoint may be defined as a particular resource or function provided by an API. API The set of instructions, such as the API, may be programmed with specific rules, for instance, at runtime, to dynamically create or adjust the label, which enables the tracking of the computer resource usage to be highly flexible and adaptable. This prevents delays due to development cycles, and enables changes to be rolled out quickly. Although reference is made throughout the present disclosure to an API as including the label, it should be understood that other types of sets of instructions may be used to include the label without departing from a scope of the present disclosure.

The counter in the key value pair increments based on an API interacting with a computing resource for a caller of the API. For instance, the counter increments each time that the API interacts with a particular computing resource or a particular type of computing resource for the caller. In some examples, the API also includes an identifier of an entity, e.g., a customer or other type of user, associated with the caller of the API. The entity may be the entity for whom the API was called.

As discussed herein, a processor of the disclosed apparatus scans the API for a specified label in the API, in which the specified label includes the counter and the value of the counter. The processor scans the API at certain time intervals or in response to receipt of an instruction to perform the scan. In addition, the processor reads the value of the counter in the specified label. The processor further records the read value of the counter and an identifier of the entity associated with the caller of the API onto a decentralized blockchain. As a result, the read value of the counter and the entity identifier are securely recorded such that the read value is tamper resistant.

In some examples, the processor initiates recording of the read value and the entity identifier onto the decentralized blockchain. In other examples, the processor sends the read value and the entity identifier to an aggregator, in which the aggregator aggregates values received from the processor and initiates recording of the aggregated values and the entity identifier onto the decentralized blockchain. In these examples, the aggregator may receive read values and entity identifiers from a plurality of apparatuses and may aggregate the received read values for the respective entity identifiers. The aggregator may also initiate recording of the read values and the respective entity identifiers onto the decentralized blockchain.

In some examples, the plurality of apparatuses scan and read labels in APIs located in multiple areas. In addition, each of the apparatuses operates independently and asynchronously with respect to each other and track computing resource usage by any of a number of various types of callers. As a result, the system including the apparatuses and the aggregators as disclosed herein enables distributed and asynchronous collection of the read values across heterogeneous environments.

Through implementation of the features of the present disclosure, the computing resource usage by the APIs for entities may efficiently and flexibly be tracked and may securely be recorded onto a decentralized blockchain. A technical improvement afforded through implementation of the present disclosure may thus be that rules and labels defining the tracking of the computing resource usage may dynamically be adjusted, which reduces development time and consumption of resources in implementing the computing resource usage tracking. Another technical improvement is that the tracked computing resource usage may be stored in a tamper-resistant manner, which enables that information to be securely stored and used with trust. As a result, that information may be used for various purposes, e.g., billing, tracking, security, etc., with knowledge that the veracity of that information may be verified through inspection of records in the decentralized blockchain.

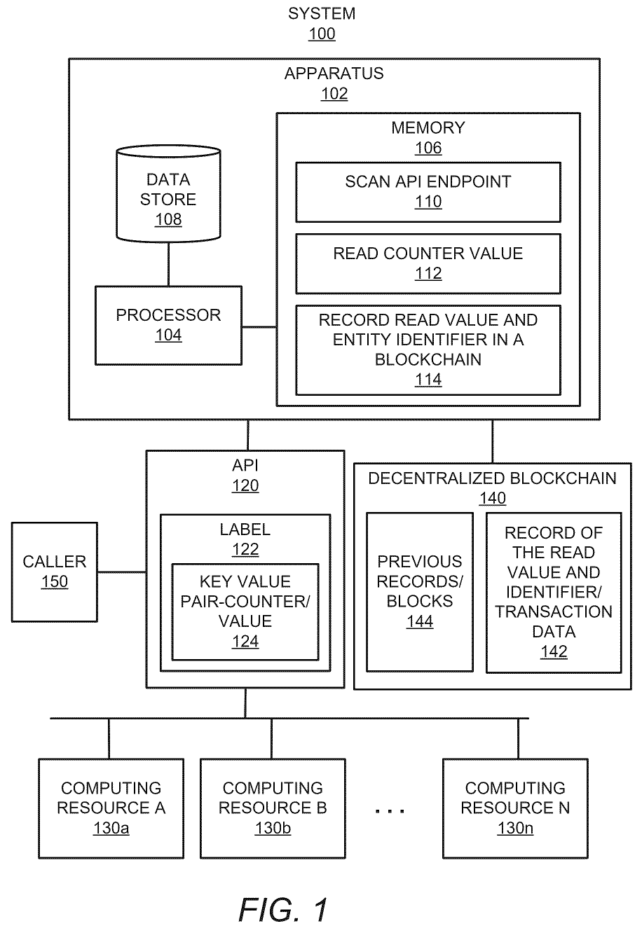

Reference is first made to FIG. 1, which shows a block diagram of a system 100 including an apparatus 102 for determining and securely recording values of counts (e.g., numbers of times, durations of times, etc.) that an API interacted with a computing resource over at least one period of time for an entity, in accordance with an embodiment of the present disclosure. It should be understood that the system 100 and the apparatus 102 shown in FIG. 1 may include additional elements and that some of the elements described herein may be removed and/or modified without departing from the scope of the present disclosure.

As shown in FIG. 1, the apparatus 102 includes a processor 104 and a memory 106. As discussed in greater detail herein, the memory 106 has stored thereon machine-readable instructions 110-114, e.g., software, that the processor 104 may execute to determine and securely record values corresponding to a count that an API 120 interacted with a computing resource 130a over at least one period of time for a caller 150 of the API 120. In some examples, the values are numbers of times that the API 120 interacted with the computing resource 130a for the caller 150 per a certain period of time, e.g., the number of times used per hour, the number of times used per day, etc. In some examples, the values are other units of usage per a certain period of time, e.g., a number of hours used in a day, a number of hours used in a week, a number of hours used in a month, etc.

As discussed herein, the caller 150 of the API 120 is associated with an entity, which is a customer, a user, or the like, that uses the caller 150 to call the API 120 to interact with the computing resource 130a. For instance, the entity is a customer of a service provider of the caller 150 (e.g., a service, a website, a program, or the like). By way of example, the values are units of usage per a certain period of time that may be used to generate billing invoices, track usage by the entity for inventory and/or security purposes, and/or the like.

The API 120 may interact with, e.g., access, one or more computing resources 130a-130n, in which the variable “n” represents a value greater than one. The computing resources 130a-130n are central processing units (CPUs), graphical processing units (GPUs), PODs, and/or the like. Some or all of the computing resources 130a-130n are located in one or more servers, the apparatus 102 (which may itself be a server), in one or more data centers, in one or more areas, or the like.

According to examples, the processor 104 executes instructions 110 to scan an API 120 for a label 122. The API 120 may be stored in a data store 108 of the apparatus 102, in a data store of a server, or the like. For instance, the API 120 is stored in a data store of a server on which the computing resource 130a is located. In another example, the API 120 is stored in one server and the computing resource 130a is located in another server or device.

As shown, the label 122 includes a key value pair 124, which includes a counter and a value of the counter. Particularly, the value of the counter is to increment, e.g., by 1 unit, based on the API 120 interacting with at least one of the computing resources 130a-130n for a caller 150. For instance, the value of the counter may increment by 1 unit each time that the application uses a computing resource 130a, each time that the application uses the computing resource 130a for a certain period of time (e.g., 1 minute, 1 hour, 2 hours, etc.), each time that the API 120 interacts with the computing resource 130a for a certain caller 150.

In some examples, a provider (e.g., an author, a programmer, a publisher, and/or the like), of an application (e.g., a service, a program, and/or the like) programs or otherwise includes the label 122 in the API 120. In this regard, the provider of the application may define the label 122 in the API 120 as to which computing resource 130a-130n usage, which entity associated with the application, which type of usage of the computing resources 130a-130n, how the usages are to be tracked, etc., are to be tracked. By way of particular example, the API 120 is an API for aKubernetes cluster, e.g., an AI POD that may have a label blockchain_counter=GPU, and/or a Proxy POD that may have a label of blockchain_counter=CPU. In other examples, the API 120 is another type of API, for instance, applied to another type of computing resource such as, a Microsoft Azure™ API, or an API of another service provider.

According to examples, the processor 104 scans the API 120 at certain intervals of time. For instance, the processor 104 scans the API 120 at an hourly interval, a daily interval, a weekly interval, a monthly interval, or the like. According to examples, the timings at which the processor 104 scans the API 120 may be user-defined. In other examples, the processor 104 scans the API 120 in response to receipt of an instruction to scan the API 120. In these examples, a user, such as an administrator, a billing personnel, and/or the like, may send an instruction to the processor 104 to scan the API 120 and the processor 104 may scan the API 120 in response to receipt of the instruction. In some examples, the user may send the instruction periodically.

The processor 104 executes the instructions 112 to read a value of the counter in the label 122. Particularly, the processor 104 may identify the label 122 having the key value pair 124 in the API 120 and may read the value identified in the key value pair 124. That is, the key value pair 124 in the API 120 may identify the type of counter to be tracked and the value of that counter corresponding to a particular label 122.

The processor 104 executes the instructions 114 to record the read value of the counter and an identifier of an entity associated with the caller 150 of the API 120 that interacted with the at least one computing resource 130a-130n in a decentralized blockchain 140, e.g., as transaction data 142. The entity associated with the caller 150 may be a client, a user, a customer, or the like, of a provider of an application corresponding to the API 120. For instance, the entity is a client that is to be invoiced according to the usage, e.g., counts, amount of time, etc., of the at least one computing resource 130a-130n by the application for the entity. The identifier of the entity associated with the usage of the at least one computing resource 130a-130n may be, for instance, a globally unique identifier (GUID) assigned to the entity. In some examples, the identifier of the entity is written into the API 120 or is stored at another location. In any of these examples, the processor 104 identifies the identifier of the entity to include that information in the transaction data 142 recorded onto the decentralized blockchain 140.

The decentralized blockchain 140 may be defined as a distributed ledger with a growing list of records (blocks) that are linked together through cryptographic hashes. Each of the records (blocks) contains a cryptographic hash of the previous record 142, a timestamp, and transaction data 142 (e.g., the read value of the counter and the identifier of the entity). As each of the records (blocks) contains the cryptographic hash of the previous record 144, the records effectively form a chain of linked data, with each additional record linking to the records before it. As a result, blockchain transactions are irreversible in that, once they are recorded, the transaction data in any given block cannot be altered retroactively without altering all subsequent blocks. In addition, the blockchain transactions may not be altered or changed without consensus from all of the parties involved in the blockchain. This prevents the deletion of any of the blockchain transactions and the record becomes immutable. The decentralized blockchain 140 may be managed by a peer-to-peer computer network for use as a public distributed ledger or for use as a private ledger.

In some examples, the processor 104 records additional data corresponding to the usage of the computing resource 130a by an application corresponding to the API 120 as part of the transaction data 142 in the decentralized blockchain 140. The additional data may include an environment identifier that may identify information pertaining to the entity and the computing resource 130a usage. By way of example, the transaction data includes a name of an independent software vendor (ISV) that initiated the transaction (e.g., the identifier of the ISV), the end customer's information (e.g., a globally unique identifier (GUID) of the end customer), the usage of the computing resource 130a (e.g., in units of usage), a timestamp, and/or the like.

In some examples, the processor 104 executes the instructions 114 to directly record the transaction data 142 onto the decentralized blockchain 140. In these examples, the processor 104 may initiate a transaction request to record the transaction data 142 onto the decentralized blockchain 140 and may broadcast the transaction request to participating nodes (e.g., computers) in a blockchain network. In addition, the transaction is validated, for instance, using a consensus algorithm. By way of example, the consensus algorithm may be similar to proof of work (POW), proof of stake (POS), practical Byzantine fault tolerance (PBFT), or the like.

After the transaction is validated, the transaction is assigned a unique hash value and the validated transaction is kept in a record. The validated transaction (block) is secured with a hash and the transaction data 142 is added to the decentralized blockchain 140. The transaction data 142 contains a reference to the previous block's hash, which effectively links the validated transaction to the previous block.

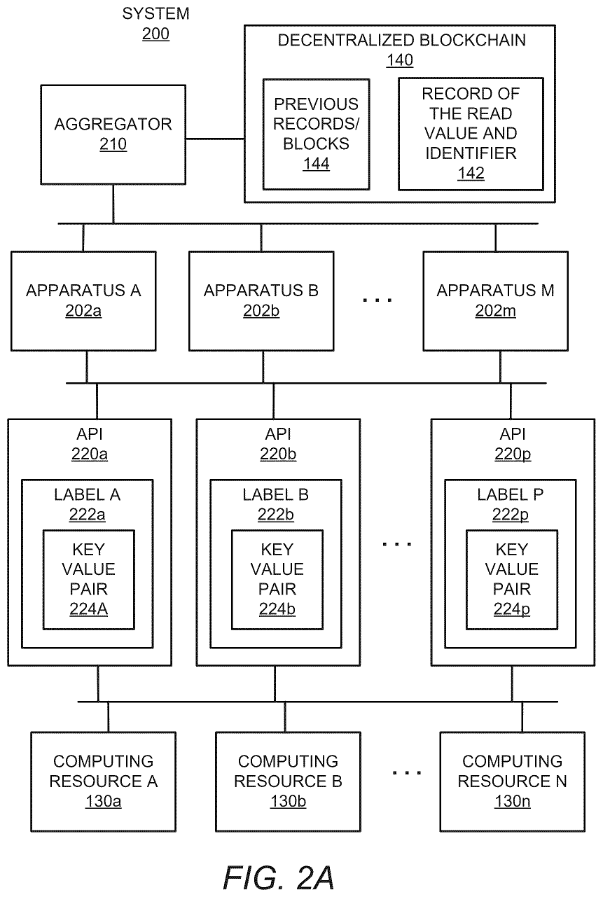

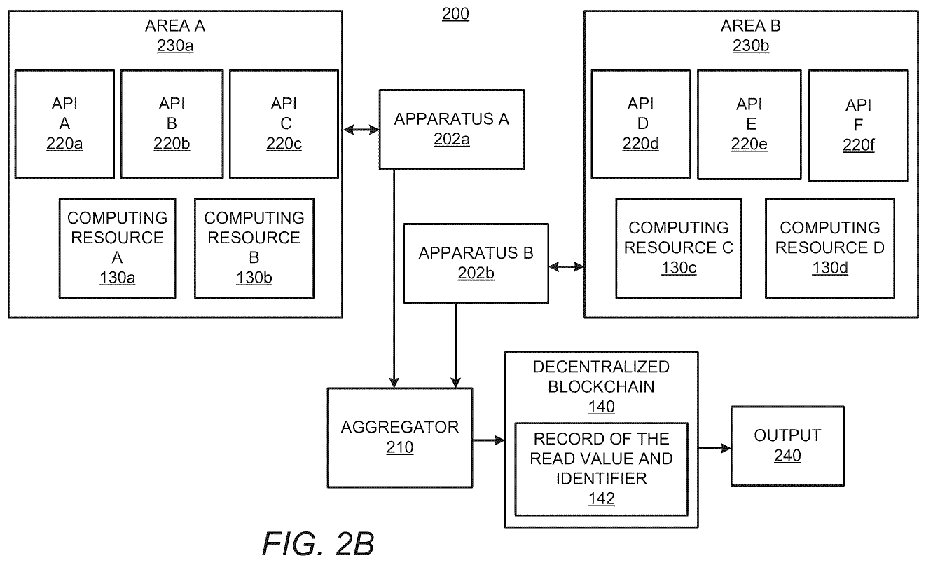

In other examples, and as discussed in greater detail hereinbelow, the processor 104 executes the instructions 114 to communicate the transaction data 142 to an aggregator 210 (FIG. 2A). In these examples, the aggregator 210 receives the transaction data 142 from the processor 104 and records the data as a transaction onto the decentralized blockchain 140. In addition, the aggregator 210 may receive transaction data from other label readers (e.g., apparatuses 202a-202m in FIG. 2A) and may aggregate the received transaction data. For instance, the aggregator 210 may sum the values of the counters received from multiple label readers for a particular entity and may record the summed values for the particular entity in the decentralized blockchain 140. In this regard, the aggregator 210 may determine a total count of times that an application used computing resources 130a-130n for a certain entity (e.g., customer, client, user, etc.) over a certain time period and that total count may be recorded onto the decentralized blockchain 140 as a transaction record.

According to examples, following addition of the transaction data 142 onto the decentralized blockchain 140, the transaction data 142 may be further processed. For instance, the transaction data 142 may be processed to determine usage of the computing resources 130a-130n by applications, e.g., callers 150 of the API 120, for a certain entity (e.g., client, customer, enterprise, or the like) over a certain period of time. In addition, the determined usage of the computing resources 130a-130n by applications for the certain entity may be used to determine usage for invoices, determine usage for tracking purposes, determine usage for potential security risks, and/or the like. Moreover, invoices, usage tracking, security risk, and/or the like, reports may be generated using the determined usage of the computing resources 130a-130n as recorded in the decentralized blockchain 140. As the transaction data 142 recorded onto the decentralized blockchain 140 is permanent and unchangeable, the invoices and/or reports may be generated with secure and unaltered transaction data 142.

The processor 104 is a semiconductor-based microprocessor, a central processing unit (CPU), an application specific integrated circuit (ASIC), a field-programmable gate array (FPGA), and/or other hardware component device. The memory 106, which may also be termed a computer readable medium, is, for example, a Random-Access memory (RAM), an Electrically Erasable Programmable Read-Only Memory (EEPROM), a storage device, or the like. In some examples, the memory 106 is a non-transitory computer readable storage medium, where the term “non-transitory” does not encompass transitory propagating signals. In any regard, the memory 106 has stored thereon machine-readable instructions that the processor 104 executes. The data store 108 may also be termed a computer readable medium, and may be a RAM, an EEPROM, a storage device, or the like.

Although the apparatus 102 is depicted as having a single processor 104, it should be understood that the apparatus 102 may include additional processors and/or cores without departing from a scope of the present disclosure. In this regard, references to a single processor 104 as well as to a single memory 106 may be understood to additionally or alternatively pertain to multiple processors 104 and/or multiple memories 106. In addition, or alternatively, the processor 104 and the memory 106 may be integrated into a single component, e.g., an integrated circuit on which both the processor 104 and the memory 106 may be provided. In addition, or alternatively, the operations described herein as being performed by the processor 104 are distributed across multiple apparatuses 102 and/or multiple processors 104.

FIG. 2A shows a block diagram of a system 200 including a plurality of apparatuses 202a-202m for determining and securely recording values of a number of counts that one or more APIs 220a-220p interacted with one or more computing resources 130a-130n over at least one period of time for one or more entities, in accordance with an embodiment of the present disclosure. FIG. 2B shows a block diagram of the system 200 shown in FIG. 2A, in which some of the APIs 220a-220p and computing resources 130a-130n are in separate areas with respect to each other, in accordance with an embodiment of the present disclosure. It should be understood that the system 200 may include additional elements and that some of the elements described herein may be removed and/or modified without departing from the scope of the present disclosure.

In FIG. 2A, the variables “m” and “p” represent values greater than one and may differ from each other. In addition, each of the apparatuses 202a-202m may be equivalent to the apparatus 102 depicted in FIG. 1 and the APIs 220a-220p may be equivalent to the API 120 depicted in FIG. 1. However, the APIs 220a-220p may interact with one or more callers 150 and/or different types of callers 150, for instance, applications from multiple independent software vendors (ISVs). In any regard, each of the apparatuses 202a-202m may scan one or more of the APIs 220a-220p for the labels 222a-222p and may read counter values in the key value pairs 224a-224p of the labels 222a-222p.

As shown in FIG. 2A, in some examples, the system 200 includes an aggregator 210 to which the apparatuses 220a-202m send read values of the key value pairs 224a-224p. The aggregator 210 is a computing device, a program executing on a computing device, a service, a program executing on a virtual machine, and/or the like. The aggregator 210 collects and aggregates the values and records the values and the identifiers of the entities corresponding to the applications that used the computing resources 130a-130n (e.g., transaction data 142) in a decentralized blockchain 140.

Thus, for instance, if a first apparatus 202a determines that the read value of the label 222a in a first API 220a is 6 and the read value of the label 222b in a second API 220b is 8, the aggregator 210 determines that the aggregated value is 14. The aggregator 210 may thus record the value of 14 onto the blockchain 140 for a certain entity and for a certain time period.

In some examples, multiple ones of the apparatuses 202a-202m may scan some of the same APIs 220a-220p for the labels 222a-222p. In other words, a first apparatus 202a and a second apparatus 202b may both scan a first API 220a for the label 222a. In addition, both the first apparatus 202a and the second apparatus 202b may send the same read values in the key value pair 224a to the aggregator 210. In this regard, the second apparatus 202b may function as a backup to the first apparatus 202a. In these examples, when both of the apparatuses 202a, 202b send the aggregator 210 the same read values, the aggregator 210 determines that the aggregator 210 has received duplicate values for the same API 120, the aggregator 210 may discard one of the values and may record the remaining values. In addition, if one of the apparatuses 202a were to fail to send the read value, the aggregator 210 may still receive the read value from the other one of the apparatuses 202b. As a result, the system 200 may have fault tolerance and may ensure high availability of the label 222a-222p readings.

As shown in FIG. 2B, the system 200 may include multiple areas 230a, 230b in which the resources 130a-130d are located. The multiple areas 230a, 230b are different regions, different areas, different systems, different clusters, and/or the like. For instance, the first area 230a is in a separate physical location, e.g., data center, county, state, country, or the like, than the second area 230b. As another example, the first area 230a is in a separate system, e.g., a server, a server rack, or the like, than the second area 230b. Although two areas 230a, 230b are shown in FIG. 2B, it should be understood that the system 200 may include any number of areas without departing from a scope of the present disclosure.

In FIG. 2B, the first area 230a is depicted as including three APIs 220a-220c and two computing resources 130a, 130b and the second area 230b is depicted as including three APIs 220d-220f and two computing resources 130c, 130d for purposes of illustration and not of limitation. In addition, a first apparatus 202a is depicted as being in communication with the APIs 220a-220c in the first area 230a and a second apparatus 202b is depicted as being in communication with the APIs 220d-220f. Moreover, each of the apparatuses 202a, 202b is depicted as being in communication with the aggregator 210. In this regard, the aggregator 210 may receive and aggregate values of labels 222a-222f in APIs 220a-220f located in multiple areas 230a, 230b.

The aggregator 210 may also record the aggregated values onto a decentralized blockchain 140 as discussed herein. The transaction data recorded onto the decentralized blockchain 140 may be output 240 in an invoice, a transaction record, a usage record, and/or the like, as discussed herein. In addition, the aggregator 210 may aggregate values for multiple entities and may record respective aggregated values for the entities in the decentralized blockchain 140. As a result, the aggregated values for each of the multiple entities may be available for use in, for instance, invoicing the entities separately, tracking separate usage by the entities, etc.

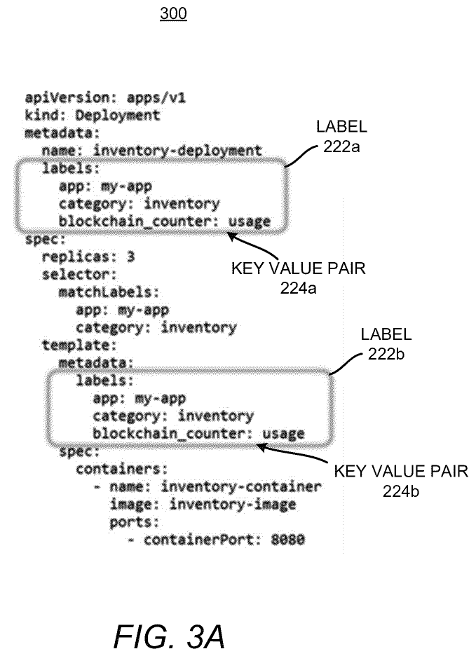

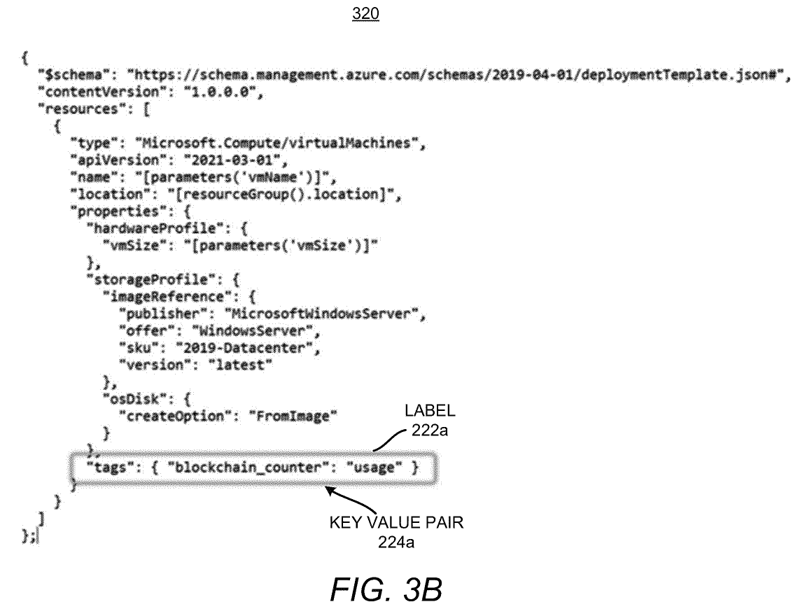

FIG. 3A shows an example of an API 300 for a Kubernetes Cluster in which labels 222a and 222b have been added, in accordance with an embodiment of the present disclosure. The API 300 may be equivalent to any of the APIs 120, 220-220p shown in FIGS. 1, 2A, and 2B and may be a YAML file for a Kubernetes Cluster. It should be understood that the API 300 shown in FIG. 3A is for illustrative purposes and is not intended to limit the present disclosure to what is depicted in that figure.

As shown in FIG. 3A, the API 300 has been generated to include a first label 222a and a second label 222b. The first label 222a includes a first key value pair 224a and the second label 222b includes a second key value pair 224b. In this example, the first and second key value pairs 224a, 224b include a “blockchain_counter” and a “usage”. In this regard, when either of the “my-app” apps is executed, which may cause a computing resource 130a to be used, the blockchain_counter usage is incremented by one unit.

FIG. 3B shows an example of an API 320, in this example, an ARM template, for a computing resource in which a label 222a has been added, in accordance with an embodiment of the present disclosure. The API 320 may be equivalent to any of the APIs 120, 220a-220p shown in FIGS. 1, 2A, and 2B and may be an ARM template for an Azure™ resource. It should be understood that the API 320 shown in FIG. 3B is for illustrative purposes and is not intended to limit the present disclosure to what is depicted in that figure.

As shown in FIG. 3B, the API 320 has been generated to include a label 222, which includes a key value pair 224a. The label 222a in the API 320 is labeled as “tags”, which may be equivalent to the label 222a. In this regard, instead of scanning for labels in the API 320, a processor may scan for “tags” in the API 320. In any regard, the key value pair 224a includes a “blockchain_counter” and a “usage”. As a result, when the API 320 is executed, which may cause a computing resource 130a to be used, the blockchain_counter usage is incremented by one unit.

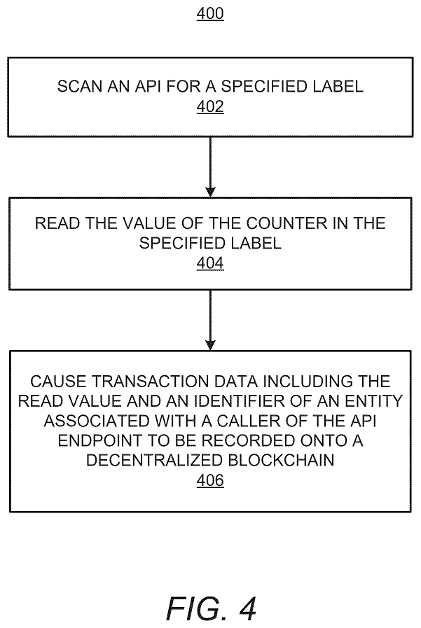

FIG. 4 depicts a flow diagram of a method 400 for tracking computing resource usage and for recording transaction data 142 corresponding to the computing resource usage onto a decentralized blockchain 140, in accordance with an embodiment of the present disclosure. It should be understood that the operations disclosed with respect to the method 400 are for illustrative purposes and that the method 400 may include additional operations or that some of the operations may be modified or deleted without departing from a scope of the present disclosure. The description of the method 400 is made with reference to the features discussed with respect to FIGS. 1, 2A, and 2B for purposes of illustration.

At block 402, a processor 104 scans an API 120 for a specified label 122, in which the specified label 122 includes a key value pair 124 of a type of counter and a value of the counter. In addition, the counter increments the value based on the API 120 interacting with a computing resource 130a for a caller 150 of the API 120. As discussed herein, an entity is associated with the caller 150, in which the entity is a client, a customer, or type of user of the caller 150, which may be an application, a service, a program, and/or the like. In addition, the processor 104 may scan the API 120 at certain intervals of time, in response to receipt of an instruction to scan the API 120, and/or the like.

At block 404, the processor 104 reads the value of the counter in the specified label 122.

At block 406, the processor 104 causes a transaction data 142 (including the read value of the counter and an identifier of the entity associated with the caller 150 of the API 120) to be recorded onto a decentralized blockchain 140. According to examples, the processor 104 causes the transaction data 142 to be recorded onto the decentralized blockchain 140 by initiating the recording of the transaction data 142 onto the decentralized blockchain 140. In other examples, the processor 104 causes the transaction data 142 to be output to an aggregator 210, in which the aggregator 210 is to initiate recordation of the read value of the counter, the identifier of the entity, and a timestamp of the recordation onto the decentralized blockchain 140.

According to examples, the processor 104 scans APIs 220a-220p for respective specified labels 222a-222p, in which the respective labels 220a-220p include counters that increment based on APIs 220a-220p interacting with computing resources 130a-130n for entities. In addition, the processor 104 reads values of the counters in the respective specified labels 220a-220p. The processor 104 also aggregates the read values of the counters and causes the aggregated read values of the counters and identifiers of at least one entity associated with usage of the at least one computing resource 130a-130n to be recorded onto the decentralized blockchain 140.

In some examples, some or all of the operations set forth in the method 400 are included as utilities, programs, or subprograms, in any desired computer accessible medium. In some examples, the method 400 is embodied by computer programs, which may exist in a variety of forms both active and inactive. For example, the computer programs exist as machine-readable instructions, including source code, object code, executable code or other formats. Any of the above, in some examples, are embodied on a non-transitory computer readable storage medium.

Examples of non-transitory computer readable storage media include computer system RAM, ROM, EPROM, EEPROM, and magnetic or optical disks or tapes. It is therefore to be understood that any electronic device capable of executing the above-described functions may perform those functions enumerated above.

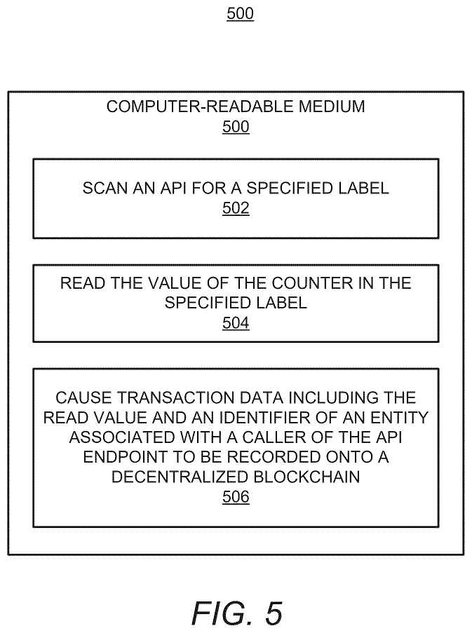

Turning now to FIG. 5, there is shown a block diagram of a computer-readable medium 500 that has stored thereon computer-readable instructions for tracking computer resource usage and for recording transaction data 142 corresponding to the computing resource usage in a decentralized blockchain 140, in accordance with an embodiment of the present disclosure. It should be understood that the computer-readable medium 500 depicted in FIG. 5 may include additional instructions and that some of the instructions described herein may be removed and/or modified without departing from the scope of the computer-readable medium 500 disclosed herein. In some examples, the computer-readable medium 500 is a non-transitory computer-readable medium, in which the term “non-transitory” does not encompass transitory propagating signals.

As shown in FIG. 5, the computer-readable medium 500 has stored thereon computer-readable instructions 502-506 that a processor, such as a processor 104 of the apparatus 102 depicted in FIG. 1 executes. The computer-readable medium 500 is an electronic, magnetic, optical, or other physical storage device that contains or stores executable instructions. The computer-readable medium 500 is, for example, Random Access memory (RAM), an Electrically Erasable Programmable Read-Only Memory (EEPROM), a storage device, an optical disc, and the like.

The processor executes the instructions 502 to scan an API 120 for a specified label 122, in which the specified label 122 includes a key value pair 124 of a type of counter and a value of the counter. In addition, the counter increments the value based on the API 120 interacting with a computing resource 130 for an entity associated with the usage of the computing resource 130a.

The processor executes the instructions 504 to read the value of the counter in the specified label 122. As discussed herein, the value of the counter may increment based on the API 120 interacting with a computing resource 130a for a particular entity.

The processor executes the instructions 506 to cause a transaction data 142 (including the read value of the counter and an identifier of the entity associated with the usage of the computing resource 130a by the application corresponding to the API 120) to be recorded onto a decentralized blockchain 140. According to examples, the processor 104 causes the transaction data 142 to be recorded onto the decentralized blockchain 140 by initiating the recording of the transaction data 142 onto the decentralized blockchain 140. In other examples, the processor 104 causes the transaction data 142 to be output to an aggregator 210, in which the aggregator 210 is to initiate recordation of the read value of the counter, the identifier of the entity, and a timestamp of the recordation onto the decentralized blockchain 140.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What has been described and illustrated herein is an example of the disclosure along with some of its variations. The terms, descriptions and figures used herein are set forth by way of illustration only and are not meant as limitations. Many variations are possible within the scope of the disclosure, which is intended to be defined by the following claims—and their equivalents—in which all terms are meant in their broadest reasonable sense unless otherwise indicated.

What is claimed is:

1. An apparatus comprising:
a processor; and
a memory on which is stored machine-readable instructions that when executed by the processor, cause the processor to:
scan an application programming interface (API) for a specified label in the API, wherein the specified label includes a counter that increments based on the API interacting with a computing resource for a caller of the API;
read a value of a counter in the specified label; and
record the read value of the counter and an identifier of an entity associated with the caller of the API onto a decentralized blockchain.

2. The apparatus of claim 1, wherein the API comprises a an API for a Kubernetes cluster.

3. The apparatus of claim 1, wherein the specified label comprises a key value pair including a type of counter and the value of the counter.

4. The apparatus of claim 1, wherein the instructions cause the processor to:
scan the API at certain intervals of time.

5. The apparatus of claim 1, wherein the computing resource comprises at least one of a central processing unit (CPU) usage, a graphical processing unit (GPU) usage, or a pod.

6. The apparatus of claim 1, wherein the instructions cause the processor to:
scan APIs for respective specified labels in the APIs, wherein the respective specified labels include counters that increment based on the APIs interacting with at least one computing resource for at least one caller of the APIs;
read values of the counters in the respective specified labels;
aggregate the read values of the counters; and
record the aggregated read values of the counters and identifiers of at least entity associated with the at least one caller of the APIs onto the decentralized blockchain.

7. The apparatus of claim 1, wherein to cause the read value of the counter and the identifier of the entity to be recorded onto the decentralized blockchain, the instructions cause the processor to:
record the read value of the counter, the identifier of the entity, and a timestamp of the recording in the decentralized blockchain.

8. The apparatus of claim 1, wherein the instructions cause the processor to:
scan the API as a backup of another apparatus that scans the API for the specified label.

9. The apparatus of claim 1, wherein to record the read value of the counter and the identifier of the entity onto the decentralized blockchain, the instructions cause the processor to:
output the read value of the counter and the identifier of the entity to an aggregator, wherein the aggregator is to initiate recordation of the read value of the counter, the identifier of the entity, and a timestamp of the recordation onto the decentralized blockchain.

10. A system for tracking and recording usage of computing resources, the system comprising:
a plurality of apparatuses, wherein each apparatus of the plurality of apparatuses comprises a processor to:
scan an application programming interface (API) for a specified label, wherein the specified label is defined in the API as a key value pair, and wherein the key value pair includes a type of counter and a value of the counter that increments based on the API interacting with at least one computing resource for a caller of the API;
read the value of the counter in the API; and
output the read value of the counter and an identifier of an entity associated with the caller of the API to an aggregator, wherein the aggregator is to initiate recording of the read values of the counter and the identifier of the entity onto a decentralized blockchain.

11. The system of claim 10, further comprising:
the aggregator, wherein the aggregator is to:
receive read values of counters from the plurality of apparatuses;
aggregate the received read values of the counters; and
initiate recording of the aggregated read values of the counters and identifiers of entities associated with callers of APIs from which the values of the counters were read onto the decentralized blockchain.

12. The system of claim 11, wherein the at least one computing resource comprises a plurality of computing resources, and wherein the aggregator is to:
determine a certain entity of the entities that associated with callers of APIs that interacted with the at least one computing resource;
aggregate, for the certain entity, the read values of the counters in the APIs for the caller associated with the certain entity; and
record, for the certain entity, data including the read values, the identifier of the certain entity, and timestamps of the recording onto the blockchain.

13. The system of claim 10, wherein a first apparatus of the plurality of apparatuses is located in a first area and a second apparatus of the plurality of apparatuses is located in a second area, and wherein the first apparatus is to scan a plurality of APIs in the first area and the second apparatus is to scan a plurality of APIs in the second area.

14. The system of claim 10, wherein a first apparatus and a second apparatus of the plurality of apparatuses are to scan a common API, wherein the second apparatus is a backup to the first apparatus.

15. The system of claim 10, wherein the interaction with at least one computing resource comprises at least one of a central processing unit (CPU) usage, a graphical processing unit (GPU) usage, or a pod.

16. The system of claim 10, wherein each of the processors in the plurality of apparatuses is further to:
scan APIs for respective specified labels, wherein the respective specified labels include counters that increment based on the APIs interacting with the at least one computing resource for callers of the APIs;
read values of the counters in the respective specified labels;
aggregate the read values of the counters; and
output the aggregated read values of the counters and identifiers of at least entity associated with the callers of the APIs to be recorded onto the decentralized blockchain.

17. A method for tracking and recording usage of computing resources, the method comprising:
scanning, by a processor, an application programming interface (API) for a specified label in the API, wherein the specified label includes a key value pair of a type of counter and a value of the counter, and wherein the counter increments based on the API interacting with a computing resource for a caller of the API;
reading, by the processor, the value of the counter in the specified label; and
causing, by the processor, a transaction data including the read value of the counter and an identifier of an entity associated with the caller of the API to be recorded onto a decentralized blockchain.

18. The method of claim 17, wherein causing the transaction data to be recorded onto the decentralized blockchain further comprises:
initiating, by the processor, recording of the transaction data onto the blockchain.

19. The method of claim 17, wherein causing the transaction data to be recorded onto the decentralized blockchain further comprises:
outputting the read value of the counter and the identifier of the entity to an aggregator, wherein the aggregator is to initiate recordation of the read value of the counter, the identifier of the entity, and a timestamp of the recordation onto the decentralized blockchain.

20. The method of claim 17, further comprising:
scanning APIs for respective specified labels in the APIs, wherein the respective specified labels include counters that increment based on APIs interacting with at least one computing resource for at least one caller;
reading values of the counters in the respective specified labels;
aggregating the read values of the counters; and
causing the aggregated read values of the counters and identifiers of at least entity associated with the at least one caller onto the decentralized blockchain.
